(19) United States
(12) Patent Application Publication
(10) Pub. No.: US 2006/0145380 A1
(43) Pub. Date: Jul. 6, 2006

(54) Method for producing parts having a compact polyurethane (pur) sealing layer

(76) Inventors: Josef Renkl, Markt Indersdorf (DE); Thomas Sonntag, Munchen (DE)

Correspondence Address: HENRY M FEIEREISEN, LLC, 350 FIFTH AVENUE, SUITE 4714, NEW YORK, NY, 10118, US

(21) Appl. No.: 10/544,582

(22) PCT Filed: Mar. 4, 2004
(86) PCT No.: PCT/EP04/02156

§ 371 Date: Aug. 3, 2005

(30) Foreign Application Priority Data
Mar. 5, 2003 (DE) 103 09 814.3

(51) Int. Cl. B29C 45/76; B29C 45/14

(52) U.S. Cl. 264/40.1; 264/328.6; 264/259; 425/564; 425/560

(57) ABSTRACT

The invention relates to a method for producing structures having a compact polyurethane (PUR) sealing layer, particularly for clear coat molding PUR in order to produce a transparent PUR sealing layer on a veneer composite. The structure is placed inside a molding tool inside of which, when closed, a gap exists between the surface of the structure to be coated and the mold inner wall opposite the surface. The components polyol and isocyanate of the compact PUR, optionally provided with additives, are injected via a mixing head and a runner into the molding tool holding the structure. The invention is characterized in that the supply of components is terminated when a predefined pressure P_{ab} (shutoff pressure) in the supply of components and/or in the flow path of the PUR mixture has been reached. This ensures that regardless of fluctuations inside the cavity due to different volumes of the structures, this cavity is always completely filled, and the same pressure is always exerted upon the structure, particularly upon the veneer layer.

The invention relates to a method for producing structures having a compact polyurethane (PUR) sealing layer according to the preamble of patent claim 1. Preferred field of application is the production of PUR sealed veneer composites by a clear coat molding process.

Molded parts for decoration in the area of the vehicle interior as well as exterior, trays and dishes for medical applications as well as furniture components and design elements require lightfast and scratch-resistant sealing of the surface. It is known to pre-treat decorative parts of wood, aluminum or carbon fibers in an elaborate way and to coat them up to ten times with unsaturated polyester varnish until the required varnish thickness has been reached. Each varnishing step is followed by an intermediate gelling for about twenty minutes at room temperature. The curing time of the layer of polyester varnish ranges typically between 48 and 72 hours. At the end, the uppermost varnish layer must still be ground planar. Such a coating with a varnish may be carried out with a spray devices for example, as referred to as prior art in DE 197 53 602 A1, or with an improved spray device according to the applied subject matter of DE 197 53 602 A1.

These spray techniques are disadvantageous because of the encountered waste of varnish slurry and emissions in the vehicle interior. A further drawback is the long time expended until a varnished product has been made.

To overcome these drawbacks, the application of the so-called CCM process (clear coat molding) is known. A method is hereby involved by which surfaces are sealed with compact polyurethane, based on the recognition that aliphatic polyurethane is lightfast and adheres very well to wood, metal as well as various fabrics. Moreover, aliphatic polyurethane is available in hard configuration as well as flexible configuration. Production of PUR sealed products is hereby realized in a single operating cycle by placing the products to be sealed or coated in a molding tool having a cavity which takes into account the thickness of the layer by leaving a gap corresponding to the layer thickness after the mold is closed. This gap is cast in a single operating cycle with a two-component polyurethane using a high-pressure process. The coating process is over following a reaction time of the polyurethane layer after few minutes and the coated product can be withdrawn from the molding tool. There is normally no need to refinish the products in the region of the PUR sealing or PUR coating.

Normally, a fixed volume of PUR as shot weight is predefined according to the cavity to be filled. The fact that the products or structures to be coated, sometimes also referred to as inserts, of a charge may have various volumes is hereby ignored. In particular, when veneer composites are involved, differences are experienced in a charge already as a result of dimensional inaccuracies during cutting of the veneer sheet as well as gluing with the metal base. Furthermore, deviations in volume are encountered also because same inserts have different veneers, for example, when a customer desires wood decorations of different woods (burl wood, birch, fir, etc.) in the interior area of a passenger car. As a consequence of these dimensional inaccuracies of the inserts, the cavity to be charged encounters respective fluctuations of the volume.

When, as is usually the case, a fixed volume of PUR is predetermined per shot, this has different negative effects depending on whether the amount of PUR injected into the cavity is too much or too little.

When the cavity is too small, an excessive amount of PUR is injected, leading to an undesired pressure rise in the cavity with the result that the cavity is pried open and overflow during injection is caused. Thus, more PUR is used up as is actually required; moreover, undesired burr is formed on the insert.

When the cavity is too great, it is not fully filled, i.e., the coating will be deficient. Furthermore, the internal pressure may not be sufficient enough to ensure a bursting of possible bubbles so that air will be trapped in the sealing layer.

The invention is thus based on the object to provide a method for producing PUR sealed products, which constantly realizes a sealing at consistent quality regardless of dimensional inaccuracies of the inserts and which in particular obviates the afore-stated drawbacks.

This object is attained by a method having the features of patent claim 1. Advantageous further developments and constructions are set forth in the sub-claims.

As the component supply is shut off when a predefined shutoff pressure has been reached, the same internal pressure is always reached in the cavity from shot to shot and the shot volume conforms to the fluctuations in the cavity. As a result, not only veneer composites with fluctuations in a charge can be easily coated with a qualitatively high-grade sealing layer but veneer composites having different veneers can be easily coated from shot to shot. Since the same internal pressure is always present, it is further ensured that any possibly encountered bubbles burst and the presence of trapped air is prevented.

Preferably, the pressure of one of the components is measured at the mixing head. In the event the mixing ratio of polyol to isocyanate is not equal 1:1, the pressure of the one component is preferably measured which has a greater fraction of PUR mixture because the pressure rise of this component is steeper toward the shot end and is thus better to monitor. It is, of course, also possible to measure the pressure of the component that represents a smaller fraction in the PUR mixture, or to measure the pressure of both components.

According to a further configuration, it is provided to additionally measure the time following commencement of the PUR injection because the shutoff pressure will not be reached or reached much later, when the molding tool has a leak, so that PUR would be wasted unnecessarily for some time. After elapse of a certain time, the component supply is cut, even when the shutoff pressure has, as of yet, not been reached. In this case, the location of a potential leakage must be checked.

Exemplary embodiments of the invention will now be described in greater detail with reference to the Figures, in which:

FIG. 1 shows a cross section through a veneer composite with a transparent PUR layer;

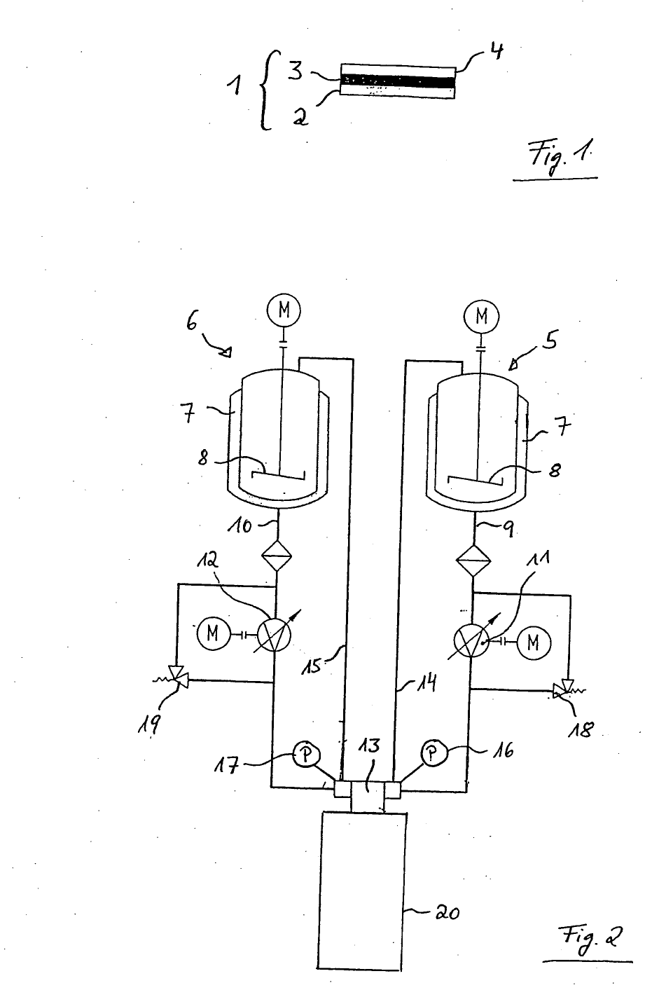

FIG. 2 shows a schematic illustration of PUR high pressure machine;

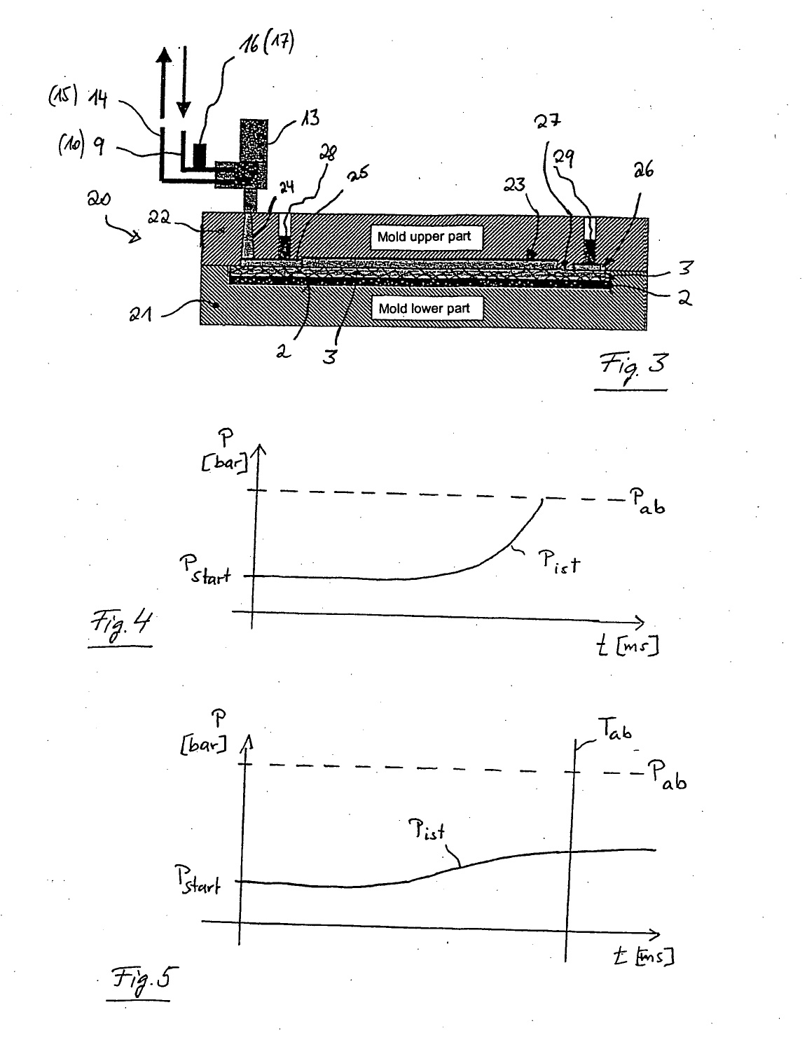

FIG. 3 shows a cross section through a molding tool with attached mixing head;

FIG. 4 shows a plot of the pressure Pᵢₛₜ of a component at the mixing head as a function of the time (normal operation);

FIG. 5 shows a plot of the pressure Pᵢₛₜ of a component at the mixing head when the molding tool has a leak.

The invention shall be described with reference to an elongated insert 1 comprised of a metal base 2 and a wood veneer 3 which is coated with a compact, non-foaming PUR layer 4 by the method according to the invention. The constituents polyol and isocyanate are each clear and transparent. In the event a colored (opaque or transparent) sealing layer is desired, suitable substances must be added to one or both components. Addition of activators and catalysts allows suitable adjustment of the reaction time for curing the compact PUR.

As can be seen from FIG. 2, the polyol and isocyanate components are stored in working containers 5 and 6 in a manner known per se which have each an insulating layer 7 and a motor-driven agitator 8. The components are fed to a mixing head 13 via supply lines 9 and 10 as well as motor-driven metering units 11 and 12, and returned to the respective working container via return lines 14 and 15, when the mixing head is in recirculation mode. The mixing head 13 is connected to a molding tool 20 and includes pressure gauges 16 and 17 for the polyol and isocyanate components. Further provided in the component circulations are safety valves 18 and 19.

FIG. 3 shows the closed state of the molding tool 20, comprised of a lower mold half 21 and an upper mold half 22. The insert made of the metal base 2 and the wood veneer 3 is disposed in the lower mold half 21. A cavity 23 is formed in the upper mold half 22 between the top side of the insert and the inner mold wall. Further provided in the upper mold half 22 on the side of the mixing head are runners 24 and 25 and on the mixing-head distal side of the cavity an overflow space 26 which is fluidly connected via a film gating 27 to the cavity 23. Provided on the mixing head 13 is a pressure gauge 16 (for the polyol components) or 17 (for the isocyanate components). Optionally, additional pressure gauges 28 may be provided in the runner and 29 in the overflow space.

The PUR clear coat molding method according to the invention is carried out as follows (see also FIG. 4): The insert 1 is deposited in the lower mold half 21, and the upper mold half 22 is placed upon the lower mold half 21 so that the molding tool 20 is closed. As the PUR assembly begins operation, the metering units 11 and 12 are powered up to apply the components pressures Pᵢₛₒ and P_{poly} until the desired mixing pressure Pₛₜₐᵣₜ has been reached which may be at 150 bar, for example. This desired mixing pressure Pₛₜₐᵣₜ of one component is stored as reference value in the machine control. Also stored in the machine control is an adjustable shutoff pressure value P_{ab} of a magnitude that depends on the structure to be produced. This value may, for example, be 15 bar above the reference value. The mixing head 13 opens now and injects the PUR mixture via the runners 24 and 25 into the cavity 23. The mixture migrates in the cavity from the runner area 24, 25 to the opposite end and fills hereby the cavity 23. No appreciable pressure rise is encountered in the cavity 23 as the filling process begins (Pᵢₛₜ is basically constant). As the filling degree increases, the internal pressure in the cavity 23 rises and thus the pressure Pᵢₛₜ of both components at the mixing head. Once the preset shutoff pressure P_{ab} has been reached, the supply of components is stopped and the mixing head 13 is switched over into the recirculation mode. The mold 20 remains now closed for the duration of a reaction time until the PUR has cured. Typical values range from few minutes and depend ultimately on the size of the insert and the thickness of the sealing layer. After curing, the molding tool 20 is opened and the veneer composite with finished seal can be removed. Subsequently, the next cycle can begin.

Instead of or in addition to the measurement of the component pressure, it is also possible to measure the pressure at other positions to determine a shutoff pressure P_{ab}, for example with the runner pressure gauge 28 or the overflow pressure gauge 29. It is also possible to form a mean value between the pressure in the runner and the pressure in the overflow for use as shutoff pressure.

In view of the fact that a same inner mold pressure is always present in the molding tool 20, it is ensured that regardless of fluctuation in the cavity 23 the latter is always completely filled and a same pressure is always exerted on the insert 1, in particular on the veneer layer 3. This further ensures the production of a qualitatively high-grade varnish layer which is free of trapped air or other defects.

As can be seen from FIG. 5, a time T_{ab} is additionally predefined which when elapsed results in a stoppage of the component supply, even when the predetermined shutoff pressure P_{ab}, has not yet been reached. In this way, unnecessary discharge of PUR mixture from the molding tool 20 is prevented in the event of leakage, when the pressure Pᵢₛₜ has not reached the shutoff pressure P_{ab}.

### LIST OF REFERENCE CHARACTERS

1 insert
2 metal base
3 wood veneer
4 PUR layer
5 polyol working container
6 isocyanate working container
7 isocyanate layer
8 agitator
9 supply line for polyol component
10 supply line for isocyanate component
11 metering unit for polyol component
12 metering unit for isocyanate component
13 mixing head
14 return line for polyol component
15 return line for isocyanate component
16 pressure gauge for polyol component
17 pressure gauge for isocyanate component
18 safety valve in polyol circulation
19 safety valve in isocyanate circulation
20 molding tool
21 lower mold half
22 upper mold half
23 cavity
24 vertical runner
25 horizontal runner
26 overflow space
27 film gating
28 pressure gauge in runner region
29 pressure gauge in overflow space

1-7. (canceled)

8. Method for producing a structure having a compact polyurethane (PUR) sealing layer, wherein the structure is placed in a molding tool which, when closed, has a gap between a surface of the structure to be coated and an inner mold wall opposite to the surface, wherein components of the compact polyurethane, optionally with additives, are injected via a mixing head and a runner into the molding tool, wherein the mixing head is connected to the molding tool for filling the gap, wherein a pressure in a component supply to the mixing head and dependent on a cavity pressure is ascertained in the runner to the molding tool or in an overflow space, and wherein the component supply is terminated and the mixing head switched over into a recirculation mode, when an ascertained pressure has reached a predefined pressure.

9. The method according to claim 8, wherein during measurement the pressure of one of the components is measured in the component supply.

10. The method according to claim 8, wherein the components are present in the compact polyurethane at a mixing ratio that is not equal 1:1 to thereby define one component present in the compact polyurethane at a greatest fraction, wherein the pressure of the one component is measured.

11. The method according to claim 8, wherein the pressure of both components is measured in the component supply.

12. The method according to claim 8, wherein the pressure is measured in addition in the runner to provide a first pressure value, and in the overflow space to provide a second pressure value, wherein a mean value of the first and second pressure values is formed, and wherein the component supply is cut when a predefined mean value has been reached.

13. The method according to claim 8, wherein in addition a time following commencement of a supply of the compact polyurethane is measured, and wherein the component supply is cut when a certain predefined time has lapsed.

14. Apparatus for producing a structure having a compact polyurethane (PUR) sealing layer, in particular a transparent PUR sealing layer by a clear coat molding process, comprising:
a mixing head for generating a polyurethane mixture;
two component supplies for conducting components of the polyurethane mixture to the mixing head;
a molding tool, wherein the mixing head is connectable to the molding tool for introduction of the polyurethane mixture via a runner into a molding tool to thereby fill the molding tool; and
a pressure gauge provided in one or both component supplies or in the runner or in an overflow space of the molding tool,
wherein the component supplies are cut and the mixing head is switched over into a recirculation mode, when a preset shutoff pressure has been reached.

15. A method for sealing a structure with a layer of polyurethane, comprising the steps of:
placing a structure in a molding tool;
closing the molding tool, thereby leaving a gap between the structure and an opposite inner mold wall;
conducting a first component of polyurethane via a first supply line and a second component of polyurethane via a second supply line into a mixing head to produce a polyurethane mixture;
injecting the polyurethane mixture into a cavity of the molding tool via a runner, thereby filling the gap;
measuring a pressure in at least one member selected from the group consisting of first and second supply lines, runner to the mixing head, and an overflow space of the cavity; and
discontinuing a flow of components through the first and second supply lines and switching the mixing head to a recirculation mode for returning the first and second components, when the measured pressure reaches a predefined level.

16. A method for sealing a structure with a layer of polyurethane, comprising the steps of:
mixing components of polyurethane in a mixing head to produce a polyurethane mixture until a desired mixing pressure is established;
injecting the polyurethane mixture from the mixing head into a cavity of a molding tool in which a structure to be coated is received;
continuing the injection step, thereby increasing an internal pressure in the cavity;
stopping the injection step, when the internal pressure reaches a predefined level, and switching the mixing head to operate in a recirculation mode; and
allowing the polyurethane mixture in the cavity to cure.

17. The method of claim 16, wherein the desired mixing pressure is 150 bar.

18. The method of claim 17, wherein the predefined level of the internal pressure is 15 bar above the desired mixing pressure.

19. Apparatus for sealing a structure with a layer of polyurethane, comprising:
a molding tool having a cavity which receives a structure to be coated;
a mixing head for producing a polyurethane mixture from different components, said mixing head being connected to the molding tool for injecting polyurethane mixture into the cavity, when a desired mixing pressure is established,
a control unit rendered operative when a pressure in the cavity reaches a predefined level to terminate further supply of polyurethane mixture into the molding tool and to switch the mixing head into recirculation mode.

20. The apparatus of claim 19, further comprising a pressure gauge operatively connected to the control unit for measuring a pressure of at least one of the components to thereby determine the pressure in the cavity.

21. The apparatus of claim 19, wherein the injection mold has a runner for conducting polyurethane mixture from the mixing head into the cavity, and further comprising a pressure gauge operatively connected to the control unit for measuring a pressure in the runner to thereby determine the pressure in the cavity.

22. The apparatus of claim 19, wherein the injection mold has an overflow space leading from the cavity, and further comprising a pressure gauge operatively connected to the control unit for measuring a pressure in the overflow space to thereby determine the pressure in the cavity.

23. The apparatus of claim 19, further comprising a measuring device operatively connected to the control unit for ascertaining a time period following commencement of injection of the polyurethane mixture by the mixing head into the cavity, said control unit being constructed to discontinue injection operation, when the time period exceeds a predetermined duration.
